(19) United States
(12) Patent Application Publication
(10) Pub. No.: US 2026/0247290 A1
(43) Pub. Date: Aug. 20, 2026

(54) POWER MANAGEMENT METHOD AND NON-AP STATION WITH DYNAMIC CAPABILITY ADJUSTMENT FOR REDUCING POWER CONSUMPTION IN POWER-SAVING MODE

(71) Applicant: MEDIATEK INC., Hsinchu City (TW)

(72) Inventors: Min-Hao Hsueh, Hsinchu City (TW); Chia-Ning Chang, Hsinchu City (TW); Chen-Yung Chao, Hsinchu City (TW)

(73) Assignee: MEDIATEK INC., Hsinchu City (TW)

(21) Appl. No.: 19/464,559

(22) Filed: Jan. 29, 2026

Related U.S. Application Data
(60) Provisional application No. 63/760,576, filed on Feb. 19, 2025.

(51) Int. Cl. H04W 52/02; H04L 1/00

(52) U.S. Cl. CPC H04W 52/0274; H04L 1/0003

(57) ABSTRACT

A power management method includes controlling a non-AP station to enter a power-saving mode, and reducing the number of antennas in operation from m to n, downgrading a level of MCS (modulation and coding scheme) from a first MCS level to a second MCS level, and/or reducing an operating bandwidth of the non-AP station from a first bandwidth to a second bandwidth. m and n are integers, and m>n.

### CROSS REFERENCE TO RELATED APPLICATIONS

This application claims the benefit of U.S. Provisional Application No. 63/760,576, filed on February 19th, 2025. The content of the application is incorporated herein by reference.

### BACKGROUND

As technological products continue to advance, the demand for power efficiency has become increasingly critical. For portable devices, improved power-saving performance can reduce the frequency of charging, enable support for more power-intensive applications, and significantly enhance the overall user experience. However, achieving improved power efficiency presents substantial challenges. For example, contemporary portable devices typically require wireless communication capabilities. To maintain reliable connectivity, these devices must remain operational even during standby mode, thereby limiting opportunities for power conservation.

### SUMMARY

An embodiment provides a power management method. The power management method includes controlling a non-AP station to enter a power-saving mode, and reducing the number of antennas in operation from m to n, downgrading a level of MCS (modulation and coding scheme) from a first MCS level to a second MCS level, and/or reducing an operating bandwidth of the non-AP station from a first bandwidth to a second bandwidth. m and n are integers, and m>n.

Another embodiment provides a non-AP station. The non-AP station includes a plurality of antennas and a controller. The plurality of antennas are used to transmit and receive wireless signals. The controller is used to control the non-AP station to enter a power-saving mode by reducing the number of antennas in operation from m to n antennas of the plurality of antennas, downgrading a level of MCS (modulation and coding scheme) from a first MCS level to a second MCS level, and/or reducing an operating bandwidth from a first bandwidth to a second bandwidth. m and n are integers, and m>n.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a non-AP station and an AP according to an embodiment.

FIG. 2 illustrates a scenario of the non-AP station according to an embodiment.

FIG. 3 illustrates another scenario of the non-AP station according to another embodiment.

FIG. 4 illustrates a flowchart of a power management method according to an embodiment.

### DETAILED DESCRIPTION

In this disclosure, when A is coupled to B, it indicates that A and B may be coupled through physical connections. The coupling between A and B may be direct or indirect through intermediate components. When X is linked to Y, it indicates that X and Y may be linked through wired, wireless, or a combination of wired and wireless means. The link between X and Y may be a hardware link or a software link, and data transmission may occur between X and Y. When "and/or" is used to combine multiple elements, it indicates one element or any combination of the multiple elements. For example, "C, D and/or E" means C, D, E, C and D, D and E, C and E, and C, D and E. In this disclosure, "AP" refers to an access point in a wireless network, which serves as a communication hub that enables wireless devices to connect to a wired network or to communicate with each other.

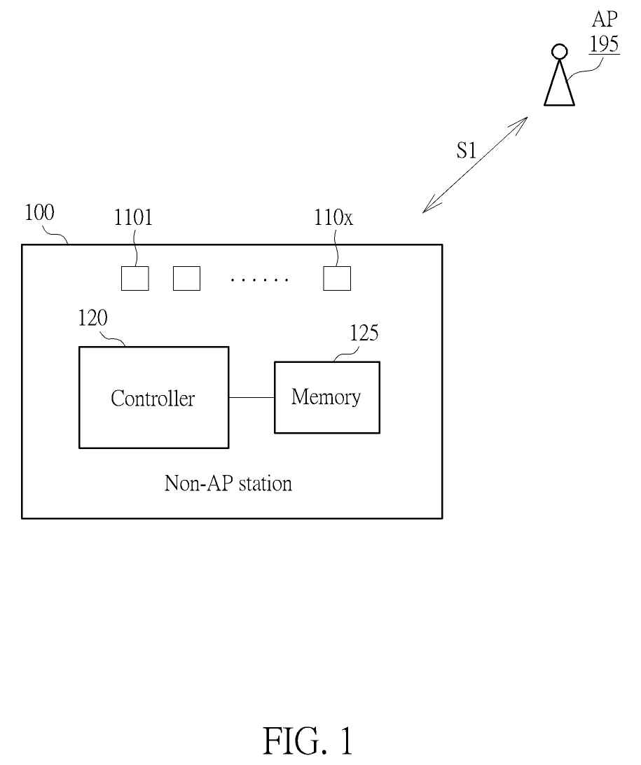

FIG. 1 illustrates a non-AP (access point) station 100 and an AP 195 according to an embodiment. The non-AP station 100 may include a plurality of antennas 1101 to 110x and a controller 120. The plurality of antennas 1101 to 110x may be used to transmit and receive wireless signals S1. The wireless signals S1 may be transmitted between the non-AP station 100 and the AP 195. When the non-AP station 100 performs predetermined tasks or transmits predetermined data, such as wirelessly downloading data or wirelessly uploading data, the non-AP station 100 may be operated in a non-power-saving mode which consumes more power to ensure stable operation. However, when the non-AP station 100 is not performing specific tasks, the non-AP station 100 may enter a power-saving mode. The non-AP station 100 does not completely cease operation but must maintain communication capability to monitor the communication status.

The controller 120 may be used to control the non-AP station 100 to enter a power-saving mode by (i) reducing the number of antennas in operation from m to n antennas of the plurality of antennas, (ii) downgrading a level of MCS (modulation and coding scheme) from a first MCS level to a second MCS level, and/or (iii) reducing an operating bandwidth from a first bandwidth to a second bandwidth. m and n are integers, and x≥m>n.

Through the above operations (i), (ii), and/or (iii), the power consumption of the non-AP station 100 during standby is effectively reduced while maintaining sufficient communication capability. Appropriate communication between the non-AP station 100 and the AP 195 is still maintained, such that the non-AP station 100 can obtain current signal strength information and can appropriately transmit and receive data and signals when needed. Related details are described below.

The non-AP station 100 may further include a memory 125. The memory 125 may be coupled to the controller 120 to store bandwidth configuration tables and various parameters and data related to the non-AP station 100. The memory 125 may be a non-volatile memory, such as flash memory, EEPROM (Electrically Erasable Programmable Read-Only Memory), or other suitable non-volatile storage devices. Related details are described hereinafter.

The non-AP station 100 may be embedded in a smartphone, a tablet, a laptop, a wearable device, an automotive communication device, an Internet of Things (IoT) device, or a battery-powered mobile device. The AP 195 may be a wireless router, a wireless access point, a base station, a mesh network node, a residential gateway, an enterprise access point, or other suitable wireless network infrastructure device.

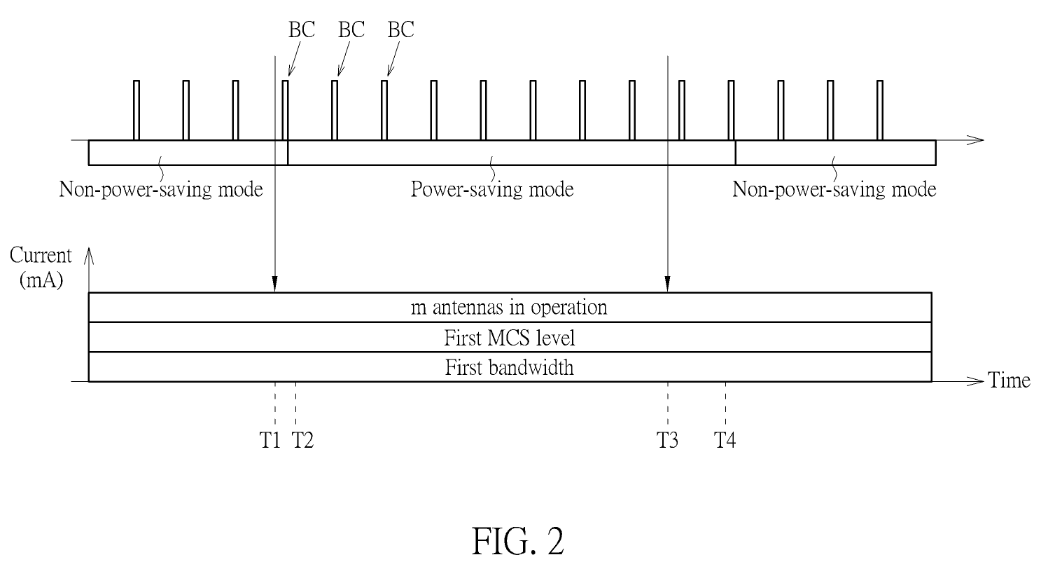

FIG. 2 illustrates a scenario of the non-AP station 100 according to an embodiment. In FIG. 2, the above operations (i), (ii), and (iii) are not performed. In FIG. 2, the vertical axis may correspond to a current consumption value of the operation of the non-AP station 100, and the unit may be, for example, mA. The horizontal axis may represent a time axis, where left to right indicates progression from earlier time to later time. At time point T1, the controller 120 may use an internal hardware signal to notify and control the non-AP station 100 to enter a power-saving mode. At time point T2, the non-AP station 100 may enter the power-saving mode. A switch state may occur between time point T1 and time point T2. The power-saving mode may be a DTIM (Delivery Traffic Indication Message) mode, which may be used to allow a station (such as a smartphone) to enter a power-saving state when idle or when predetermined conditions are satisfied. In the power-saving mode, the non-AP station 100 may periodically receive beacon signals transmitted by the AP 195. For example, when the non-AP station 100 is not performing specific tasks, the non-AP station 100 may enter the DTIM mode. At time point T3, the controller 120 may use an internal hardware signal to notify and control the non-AP station 100 to leave the power-saving mode. At time point T4, the non-AP station 100 may leave the power-saving mode. A transition state may occur between time point T3 and time point T4.

As shown in FIG. 2, in the non-power-saving mode (for example, before time point T1 and after time point T4) and in the power-saving mode (for example, between time point T2 and time point T3), the non-AP station 100 may use m antennas to receive and transmit signals, the non-AP station 100 may use a first MCS (modulation and coding scheme) level, and the non-AP station 100 may operate at a first bandwidth. As shown in FIG. 2, the settings regarding the number of antennas in operation, the MCS level, and the bandwidth all remain unchanged. The MCS level can be used to define a combination of modulation scheme and coding rate that determines data transmission efficiency and reliability. Higher MCS levels enable faster data rates but require higher signal quality, while lower MCS levels can provide communication under poor signal conditions.

In FIG. 2, there are some signals represented in the form of bar-shaped pulses, which may correspond to beacon signals BC. The beacon signals BC may be used to provide network information, synchronization timing, and traffic indication to stations, allowing the non-AP station 100 to maintain awareness of the network status and determine whether buffered data is waiting at the AP 195.

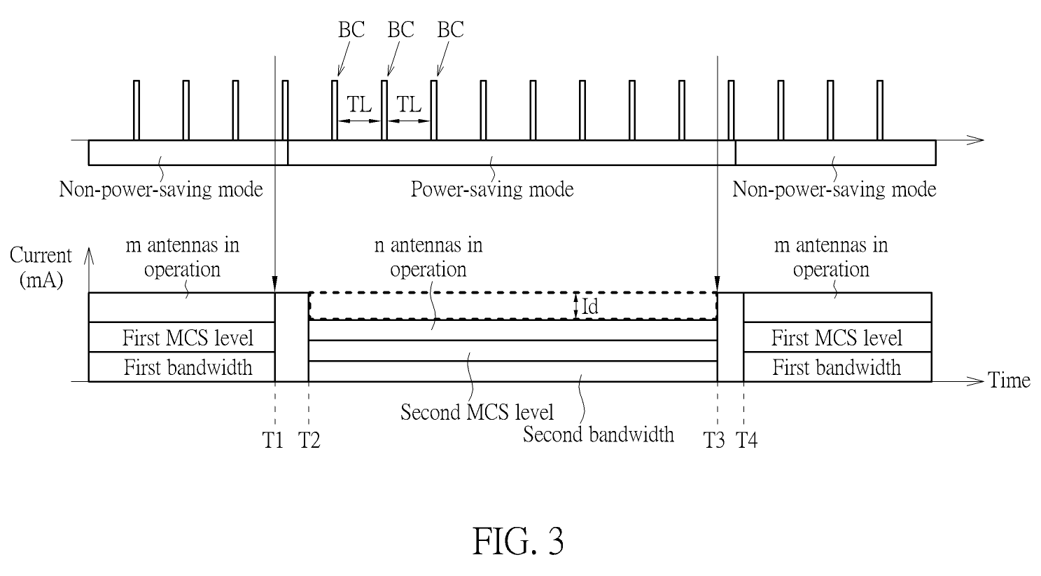

Using the configuration of FIG. 2 can effectively maintain communication, but the power-saving effect may be further improved. Therefore, an embodiment may use the configuration of FIG. 3 as described below.

FIG. 3 illustrates another scenario of the non-AP station 100 according to another embodiment. In FIG. 3, the above operations (i), (ii), and (iii) are performed. However, FIG. 3 is merely an example. According to embodiments, one or any combination of the operations (i), (ii), and (iii) may be performed. That is, the operations (i), (ii), and/or (iii) may be performed. The similarities between FIG. 3 and FIG. 2 are not reiterated. Among the operations (i), (ii), and (iii), performing one operation can reduce power consumption, performing two operations can further reduce power consumption, and performing all three operations can achieve even greater power savings. When performing one or more of the operations (i), (ii), and (iii), it is still necessary to ensure that the non-AP station 100 can properly receive the beacon signals BC. Internal programs and firmware of the non-AP station 100 may support appropriate hardware signal control.

Compared with FIG. 2, in FIG. 3, the number of antennas in operation may be reduced from m to n. The non-AP station 100 may use a second MCS level, wherein the second MCS level is lower than the first MCS level of FIG. 2. The non-AP station 100 may use a second bandwidth, which is smaller than the first bandwidth of FIG. 2.

Reducing the number of antennas in operation, downgrading the MCS level, and reducing the bandwidth may each decrease the consumed current. Therefore, as shown in FIG. 3, between time point T2 and time point T3, the overall consumed current may be reduced. A current difference Id in FIG. 3 may correspond to the conserved power, that is, the power benefit.

The power-saving mode of FIGS. 2 and 3 may be a DTIM (delivery traffic indication message) mode for the non-AP station 100 to periodically receive beacon signals BC from the access point 195. However, embodiments are not limited thereto. In other situations where power saving is needed, the configuration of FIG. 3 may be adopted to perform operations (i), (ii), and/or (iii) to reduce the consumed current.

As shown in FIG. 3, at time point T3, the non-AP station 100 may be controlled to leave the power-saving mode by increasing the number of antennas used from n to m, upgrading the MCS (modulation and coding scheme) level, and/or increasing the operating bandwidth of the non-AP station 100 to enter the non-power-saving mode so that the non-AP station 100 achieves higher performance.

For example, at time point T1 in FIG. 3, the non-AP station 100 may enter the power-saving mode by generating a QoS null packet to trigger the transition. At time point T3, the non-AP station 100 may be controlled to leave the power-saving mode by generating a QoS null packet to trigger the non-AP station 100 to leave the power-saving mode. Here, a QoS null packet may be a special control frame in wireless communication that carries no data payload but is used to convey control information, such as power management status changes, to the access point, allowing the station to signal state transitions without transmitting actual user data. The QoS null packet may follow IEEE 802.11 standards, wherein a power management (PM) bit in a frame control field of the QoS null packet may be set to indicate whether the non-AP station 100 is entering or leaving the power-saving mode.

According to an embodiment, the operational sequence may be as follows. The non-AP station 100 generates an internal hardware signal, generates a QoS null packet, and then enters the power-saving mode. The non-AP station 100 generates an internal hardware signal, generates a QoS null packet, and then leaves the power-saving mode.

To further save power, additional operations may be performed within the power-saving mode. Between receiving the beacon signals BC, there may be time periods TL during which the beacon signals BC are not received. During the time periods TL, the non-AP station 100 may operate at a lowest power consumption level. For example, the non-AP station 100 may enter a deep sleep state.

The beacon signals BC received by the non-AP station 100 may be sent with an OFDM (Orthogonal Frequency-Division Multiplexing) rate, a CCK (Complementary Code Keying) rate, or other suitable rates. Here, OFDM can be a modulation technique that divides data across multiple subcarriers to achieve higher data rates and better resistance to interference. CCK can be a modulation scheme used in WiFi standards that provides data transmission at lower speeds.

In FIGS. 1 and 3, the non-AP station 100 may send a first packet to the access point 195 to notify the access point 195 that the non-AP station 100 is entering the power-saving mode. For example, the first packet may be sent at time point T1, time point T2, or between time point T1 and time point T2.

The non-AP station 100 may send a second packet to the access point 195 to notify the access point 195 that the non-AP station 100 has left the power-saving mode. For example, the second packet may be sent at time point T3, time point T4, or between time point T3 and time point T4.

Regarding the aforementioned bandwidth switching, the description is as follows. In the non-AP station 100, a memory may be used to store bandwidth configuration tables. A bandwidth configuration table may include parameters such as center frequency, calibration data, and channel settings required for operating at a specific bandwidth. The non-AP station 100 may store a first bandwidth configuration table for the first bandwidth and a second bandwidth configuration table for the second bandwidth. Reducing the operating bandwidth may include switching from the first bandwidth configuration table to the second bandwidth configuration table, where the first bandwidth configuration table occupies more memory space than the second bandwidth configuration table.

For example, from FIGS. 2 and 3, the number of antennas in operation may be reduced from 2 to 1. The MCS level may be downgraded from SX BE (MCS 13) to SX AC (MCS 0/4), wherein SX BE may support higher-performance WiFi configurations and SX AC may support basic WiFi configurations. The bandwidth may be reduced from BW 320 (e.g., 320 MHz) to BW 20 (e.g., 20 MHz). However, the above is only an example. Users may appropriately adjust the settings according to requirements and hardware/software/firmware specifications.

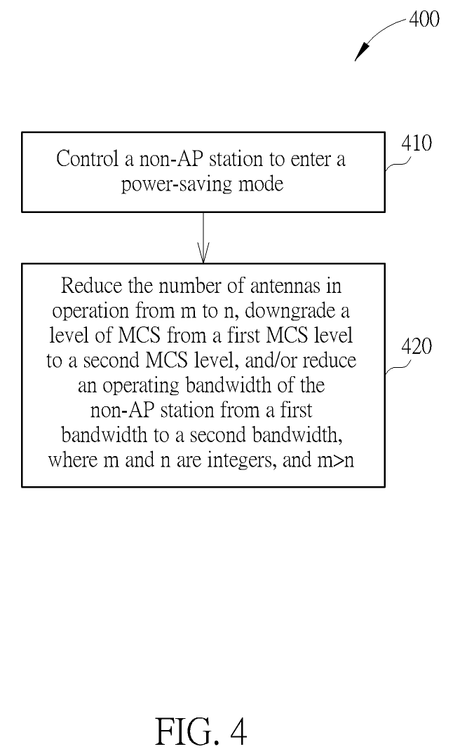

FIG. 4 illustrates a flowchart of a power management method 400 according to an embodiment. The power management method 400 may include the following steps.

Step 410: Control a non-AP station 100 to enter a power-saving mode; and

Step 420: Reduce the number of antennas in operation from m to n, downgrade a level of MCS from a first MCS level to a second MCS level, and/or reduce an operating bandwidth of the non-AP station 100 from a first bandwidth to a second bandwidth, where m and n are integers, and m>n.

Using the non-AP station 100 and the power management method 400, fast switching is achieved. Through hardware signal control combined with preset bandwidth tables, seamless capability switching is realized. An AP coordination mechanism is supported, allowing the AP 195 to be notified for packet buffering coordination when entering and leaving the power-saving mode.

In summary, the non-AP station 100, the power management method 400, and the aforementioned techniques provide dynamic capability adjustment, enabling the non-AP station 100 to effectively save power when entering the power-saving mode. Battery runtime of mobile devices is effectively extended without compromising network connectivity. The techniques are applicable to battery-powered devices such as smartphones, tablets, and laptops, and improve user convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management method, comprising:
controlling a non-AP station to enter a power-saving mode; and
reducing a number of antennas in operation from m to n, downgrading a level of MCS (modulation and coding scheme) from a first MCS level to a second MCS level, and/or reducing an operating bandwidth of the non-AP station from a first bandwidth to a second bandwidth;
wherein m and n are integers, m>n.

2. The power management method of claim 1, wherein the power-saving mode is a DTIM (delivery traffic indication message) mode for the non-AP station to periodically receive beacon signals from an access point.

3. The power management method of claim 1, further comprising:
controlling the non-AP station to leave the power-saving mode; and
increasing the number of antennas in operation from n to m, upgrading the level of MCS (modulation and coding scheme), and/or increasing the operating bandwidth of the non-AP station.

4. The power management method of claim 3, wherein:
controlling the non-AP station to leave the power-saving mode comprises generating a QoS null packet to trigger the non-AP station to leave the power-saving mode.

5. The power management method of claim 1, wherein:
controlling the non-AP station to enter the power-saving mode comprises generating a QoS null packet to trigger the non-AP station to enter the power-saving mode.

6. The power management method of claim 1, wherein the power-saving mode comprises:
the non-AP station receiving beacon signals using the n antennas, the second MCS level, and/or the second bandwidth; and
the non-AP station operating at a lowest power consumption level when not receiving beacon signals.

7. The power management method of claim 6, wherein the beacon signals are sent with an OFDM (Orthogonal Frequency-Division Multiplexing) rate or a CCK (Complementary Code Keying) rate.

8. The power management method of claim 1, further comprising:
sending a first packet to an access point to notify the access point that the non-AP station is entering the power-saving mode.

9. The power management method of claim 1, further comprising:
sending a second packet to an access point to notify the access point that the non-AP station has left the power-saving mode.

10. The power management method of claim 1, wherein:
the non-AP station stores a first bandwidth configuration table for the first bandwidth and a second bandwidth configuration table for the second bandwidth; and
reducing the operating bandwidth comprises switching from the first bandwidth configuration table to the second bandwidth configuration table;
wherein the first bandwidth configuration table occupies more memory space than the second bandwidth configuration table.

11. A non-AP station, comprising:
a plurality of antennas configured to transmit and receive wireless signals; and
a controller configured to control the non-AP station to enter a power-saving mode by reducing a number of antennas in operation from m to n antennas of the plurality of antennas, downgrading a level of MCS (modulation and coding scheme) from a first MCS level to a second MCS level, and/or reducing an operating bandwidth from a first bandwidth to a second bandwidth;
wherein m and n are integers, and m>n.

12. The non-AP station of claim 11, wherein the power-saving mode is a DTIM (delivery traffic indication message) mode for the non-AP station to periodically receive beacon signals from an access point.

13. The non-AP station of claim 11, further comprising:
a non-volatile memory configured to store a first bandwidth configuration table for the first bandwidth and a second bandwidth configuration table for the second bandwidth;
wherein the first bandwidth configuration table occupies more memory space than the second bandwidth configuration table in the non-volatile memory.

14. The non-AP station of claim 11, wherein the non-AP station is embedded in a smartphone, a tablet, a laptop, a wearable device, an automotive communication device, an Internet of Things (IoT) device, or a battery-powered mobile device.
